(19) United States
(12) Patent Application Publication
(10) Pub. No.: US 2012/0067448 A1
(43) Pub. Date: Mar. 22, 2012

(54) LINE ELEMENT

(75) Inventors: Andreas BAUER, Maintal (DE); Marc RASTETTER, Biebergemuend (DE); Stephan MANN, Biebergemuend (DE); Patrick SEMMEL, Linsengericht (DE)

(73) Assignee: NORMA GERMANY GMBH, Maintal (DE)

(21) Appl. No.: 13/224,805

(22) Filed: Sep. 2, 2011

(30) Foreign Application Priority Data
Sep. 16, 2010 (DE) 10 2010 045 714.0

(51) Int. Cl. F16L 55/00; B23P 19/00

(52) U.S. Cl. 138/103; 29/428

(57) ABSTRACT

Line element and method for forming a line element. The line element includes a fluid line, and a housing structured and arranged to surround the fluid line in a radially fluid-tight manner. An annular space is formed between the fluid line and the housing, which is filled at least in part with a compressible medium, and the fluid line has at least one opening inside the annular space.

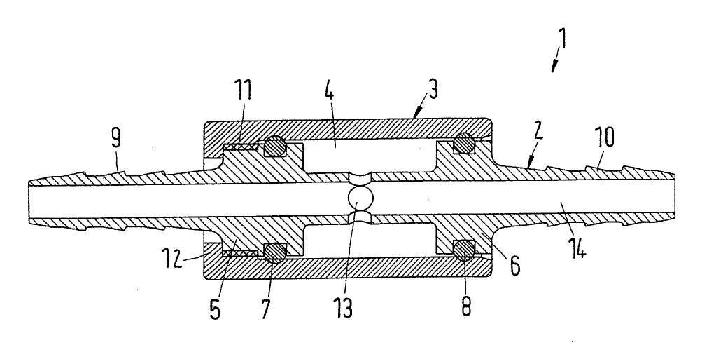

### CROSS-REFERENCE TO RELATED APPLICATIONS

The present application claims priority under 35 U.S.C. §119 of German Patent Application No. 10 2010 045 714.0, filed on Sep. 16, 2010, the disclosure of which is expressly incorporated by reference herein in its entirety.

### BACKGROUND OF THE INVENTION

1. Field of the Invention

The invention relates to a line element that has a fluid line and a housing.

2. Discussion of Background Information

Line elements of this type are used, for example, in motor vehicles for conveying engine coolant or as so-called urea lines. Lines that are used to supply urea, for example, in order to contribute to a clean combustion in diesel engines, are referred to as urea lines.

In the case of fluid lines filled with liquid, there is the problem in particular with motor vehicles in winter that, with longer downtime of the motor vehicles, the fluid located in the lines can freeze. Urea, for example, freezes at −11° C.

The freezing of the liquids results in an increase in volume and thus a compressive load on the lines. In the worst case, damage to the lines or damage to connecting elements of the lines can occur as a result.

In order to prevent freezing, it is known to heat the lines. However, heating cannot be maintained over a longer period in which a vehicle is left standing. So freezing cannot be reliably prevented by heating.

### SUMMARY OF THE INVENTION

Embodiments of the present invention reduce the risk of damage occurring when a fluid freezes.

According to embodiments, a line element of the type mentioned at the outset includes a housing surrounding the fluid line in a radially fluid-tight manner. An annular space, formed between the fluid line and the housing, is filled at least in part with a compressible medium. The fluid line has at least one opening inside the annular space.

A pressure-compensating space as it were is provided inside the housing, so that a pressure that is generated in the fluid line during the freezing of the fluid can escape into the annular space. A reduction in volume of the compressible medium thereby occurs. The fluid line itself is thereby decompressed. The annular space is prevented from completely filling with the fluid by way of the compressible medium in the liquid state of the fluid. A pressure exerted on the line element due to the freezing of the fluid is reduced so much through this embodiment that no damage to the fluid line or the line element occurs. In particular, pressure peaks are thereby reduced. The compressible medium should of course thereby retain its desired compressibility at the usual subfreezing temperatures. The line element is thus embodied or formed as a pressure-compensating element.

Preferably, the opening is spaced apart from axial boundaries of the annular space. In particular, the opening is centrally arranged between the axial boundaries, so as to have an equal distance from the respective boundaries. A positional independence of the line element is achieved through this. Regardless of the position of the line element, the annular space cannot be filled completely with fluid.

Preferably, the compressible medium is thereby formed by air enclosed in the housing. This air is located throughout the entire annular space before the line element is filled. When the fluid is introduced into the fluid lines, the fluid passes through the opening into the annular space. In this way, air contained in the annular space can escape through this opening. When the fluid line is filled so far that the opening is completely covered, the air still remaining in the annular space can no longer escape, since the housing is connected to the fluid line in a fluid-tight manner. This enclosed air then forms the compressible medium. This embodiment makes a very cost-effective production of the line element possible. Moreover, the fluid is not contaminated by the compressible medium.

In another preferred embodiment, the compressible medium is embodied as a foam, in particular, as a closed-pore foam. The annular space can then be embodied or formed completely by the foam. A compression of the foam occurs under pressure and thus a reduction of pressure in the fluid line. With a closed pore foam, absorption of the fluid does not occur thereby. Through this embodiment, the compressibility of the medium can be adjusted relatively well.

In a further preferred embodiment, the compressible medium has an elastic container, in which a compressible fluid, in particular air, is enclosed. This container is thereby arranged in the annular space. With an increase in pressure in the fluid line, this pressure is transmitted through the opening onto the elastic container, which is compressed. A reduction of the pressure prevailing in the fluid line occurs.

Preferably, the housing is embodied or formed as an annular sleeve and the axial boundaries are embodied or formed as ring flanges. Optionally, the ring flanges are connected to the fluid line by adhesive force, so that they are embodied or formed in particular in one piece with the fluid line. The production of an annular sleeve is relatively simple. A circumferential surface of the annular sleeve is completely closed, that is, in any case, closed in a fluid-tight manner. A sealing of the ring flanges to the fluid line is ensured by the connection by adhesive force or even one-piece connection. The sleeve can now be pushed onto the ring flanges by a press fit, whereby a sufficient tightness is already possibly achieved. This is in particular the case when either the ring flanges or the annular sleeve are made from a relatively soft material.

Advantageously, one respective sealing element is arranged between the housing and each of the ring flanges. A fluid-tight connection between the annular sleeve and the ring flanges is ensured by this sealing element.

Preferably, the opening is embodied or formed as an annular gap. The fluid line is thus in two parts, as it were, and both parts are separated by the annular gap. However, the fluid line is held together by the housing. If necessary, further securing elements can be provided in order to prevent an axial removal of the fluid line parts from the housing. The embodiment of an annular gap is relatively simple. For example, the fluid line can simply be cut through between the two ring flanges, so that the housing is subsequently attached.

In another preferred embodiment, three, four or more openings are provided, which are embodied or formed axially at the same height in the fluid line. The openings are optionally distributed uniformly over a circumference of the fluid line. Through the use of several openings, overall a relatively large cross section can be provided for the fluid to flow into the annular space, without the fluid line having to be divided. Since these openings are now all arranged at the same height, in particular when they are also uniformly distributed over a circumference of the fluid line, a uniform filling of the annular space by the fluid is ensured, regardless of the position. An equally large quantity of air is thus always enclosed in the annular space. In the case of four openings, respectively two openings thereby lie diametrically opposite one another.

Preferably, the fluid line has on at least one end a connection geometry, in particular an insert region. The line element can then be connected to other line elements relatively easily. The connection geometry can thereby project axially out of the housing. Both ends of the fluid line can be embodied identically. If both ends of the fluid line are embodied or formed as an insert region, for example, which in each case projects axially out of the housing, the line element can be inserted as a connecting element between two hose ends. The hose ends are then simply guided via the insert region and optionally secured with the aid of hose clamps. The line element can also be supplemented subsequently relatively easily.

Embodiments of the invention are directed to a line element. The line element includes a fluid line, and a housing structured and arranged to surround the fluid line in a radially fluid-tight manner. An annular space is formed between the fluid line and the housing, which is filled at least in part with a compressible medium, and the fluid line has at least one opening inside the annular space.

According to embodiments of the present invention, the annular space may further be formed between axial boundaries. The at least one opening can be spaced apart from the axial boundaries.

In accordance with other embodiments, the compressible medium may include air enclosed in the housing.

According to still other embodiments of the invention, the compressible medium can be a foam. Further, the foam may be a closed-pore foam.

In accordance with other embodiments, the housing may include an elastic container structured to contain a compressible fluid. The compressible fluid can be air.

Further, the housing may include an annular sleeve, and the axial boundaries can include ring flanges. The ring flanges can be connected to the fluid line by adhesive force. Further, the ring flanges may be connected in one piece with the fluid line. Moreover, one sealing element is respectively arranged between the housing and the ring flanges.

According to other embodiments, the at least one opening can be formed as an annular gap.

Still further, the at least one opening may include at least three openings formed at a same axial height along the fluid line. The at least three openings includes one of four or five openings that are uniformly distributed over a circumference of the fluid line.

According to still other embodiments of the instant invention, the fluid line has on at least one end a connection geometry. The connection geometry may include an insert region.

Embodiments of the invention are directed to a method for forming a line element. The method includes pulling a housing over a fluid line to form an annular space between the housing and the fluid line. At least one opening is formed in the fluid line to communicate with the annular space.

In accordance with still yet other embodiments of the present invention, the fluid line can include axial boundaries that further form the annular space. Moreover, the method can further include positioning a respective seal between the axial boundaries and the housing.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the drawing by way of non-limiting example of an exemplary embodiment of the present invention, and wherein:

The FIGURE illustrates a cross section through a line element.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

In the FIGURE, a line element 1 with a fluid line 2 is shown. A housing 3 surrounds fluid line 2 in an annular manner, and an annular space 4 is embodied or formed between housing 3 and fluid line 2. Annular space 4 is limited in the axial direction by a respective ring flange 5, 6. The ring flanges 5, 6 are embodied in one piece with the fluid line 2.

Housing 3 is embodied or formed as an annular sleeve, thus having a completely closed circumferential surface. One sealing element 7, 8 is respectively arranged between ring flanges 5, 6 and housing 3. Sealing elements 7, 8 can be embodied or formed as ring seals.

Fluid line 2 penetrates housing 3 in the axial direction and projects on both sides of housing 3 approximately to a same extent. In the exemplary embodiment, this projecting region of fluid line 2 is provided on both sides with an identically embodied connection geometry 9, 10. Connection geometry 9, 10 is hereby embodied or formed as an insert region, which can be inserted, e.g., into a hose end. Housing 3 is pushed over fluid line 2 in the axial direction. Further, between ring flange 5 and housing 3 a snap ring 11 is arranged in order to guarantee a frictional connection between housing 3 and fluid line 2. Housing 3 is provided on a front face with a flange 12 projecting inwards, which serves as an insert limitation and in the assembled state shown bears against an axial outside of ring flange 5. The position of housing 3 is thereby precisely defined with respect to fluid line 2. A removal of housing 3 is also possible only in a predetermined direction. An accidental shift is therefore unlikely.

Fluid line 2 is provided with a total of four openings 13, which connect an interior 14 of the fluid line 2 to the annular space 4. Openings 13 are all arranged at a same axial height with respect to fluid line 2. Openings 13 are spaced apart from both ring flanges 5, 6, which form the axial limitation or boundary of annular space 4. Regardless of the position of line element 1, annular space 4 cannot be completely filled with a fluid that reaches annular space 4 through interior 14 and openings 13.

In the shipped state, the interior 14 and annular space 4 are filled with air. If line element 1 is now used in a line and filled with a fluid, interior 14 is filled and fluid also reaches annular space 4 via openings 13. As long as openings 13 are not yet fully covered by fluid, an air volume located in interior 14 can escape through openings 13. A complete escape of the air enclosed in the annular space is not possible, however. Instead, the air in annular space 4 is held between the fluid-tight connection of housing 3 and fluid line 2 and the fluid arranged in fluid line 2.

If the fluid now starts to freeze, its volume increases. Since the air located in annular space 4 is a compressible medium, an equalization of pressure can take place through openings 13 with compression of the air. The compressive load acting on the line element 1 due to the freezing of the fluid is thus reduced.

In the exemplary embodiment shown, the air enclosed in the housing is used as compressible medium. In addition to or instead of the air, a foam or an elastic container filled with a gas or, for example, a rubber structure can be used, which is arranged in annular space 4. This too makes it possible to avoid a dangerous increase in pressure in line element 1 due to freezing of the fluid guided through line element 1.

Other connection geometries of fluid line 2 are likewise conceivable. It is not absolutely necessary either for the housing to be embodied or formed axially shorter than the fluid line. Instead, the housing can also project beyond the connection geometry, for example, and thus protect against environmental effects.

Instead of the four openings shown, for example, a different number of openings, such as, for example, three or five openings can also be used. It is also possible to provide an annular gap instead of the openings. However, in this case a corresponding axial positional securing of the parts of the fluid line inside the housing is necessary.

Through the embodiment according to the invention, a fluid-tight annular space is provided between fluid line 2 and housing 3, which is used for the equalization of pressure in the event that fluid guided through fluid line 2 freezes. The compressive load exerted on the line element due to the freezing of the fluid is reduced thereby, so that it remains in a non-critical range, in which damage to the line element is not anticipated. Damage to adjacent elements is also prevented thereby.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A line element comprising:
a fluid line;
a housing structured and arranged to surround the fluid line in a radially fluid-tight manner;
wherein an annular space is formed between the fluid line and the housing, which is filled at least in part with a compressible medium, and the fluid line has at least one opening inside the annular space.

2. The line element according to claim 1, wherein the annular space is further formed between axial boundaries.

3. The line element according to claim 2, wherein the at least one opening is spaced apart from the axial boundaries.

4. The line element according to claim 1, wherein the compressible medium comprises air enclosed in the housing.

5. The line element according to claim 1, wherein the compressible medium comprises a foam.

6. The line element according to claim 5, wherein the foam is a closed-pore foam.

7. The line element according to claim 1, wherein the housing comprises an elastic container structured to contain a compressible fluid.

8. The line element according to claim 7, wherein the compressible fluid is air.

9. The line element according to claim 2, wherein the housing comprises an annular sleeve, and the axial boundaries comprise ring flanges.

10. The line element according to claim 9, wherein the ring flanges are connected to the fluid line by adhesive force.

11. The line element according to claim 9, wherein the ring flanges are connected in one piece with the fluid line.

12. The line element according to claim 9, wherein one sealing element is respectively arranged between the housing and the ring flanges.

13. The line element according to claim 1, wherein the at least one opening is formed as an annular gap.

14. The line element according to claim 1, wherein the at least three openings includes one of four or five openings that are uniformly distributed over a circumference of the fluid line.

15. The line element according to claim 14, wherein the at least three openings are uniformly distributed over a circumference of the fluid line.

16. The line element according to claim 1, wherein the fluid line has on at least one end a connection geometry.

17. The line element according to claim 16, wherein the connection geometry comprises an insert region.

18. A method for forming a line element, comprising:
pulling a housing over a fluid line to form an annular space between the housing and the fluid line,
wherein at least one opening is formed in the fluid line to communicate with the annular space.

19. The method according to claim 18, wherein the fluid line includes axial boundaries that further form the annular space.

20. The method according to claim 19, further comprising positioning a respective seal between the axial boundaries and the housing.
